(19) United States
(12) Patent Application Publication
(10) Pub. No.: US 2012/0179657 A1
(43) Pub. Date: Jul. 12, 2012

(54) HUMAN RESOURCES MANAGEMENT SYSTEM AND METHOD INCLUDING PERSONNEL CHANGE REQUEST PROCESSING

(76) Inventors: Eric Delafortrie, Neerijse (BE); Ivan Mostien, Antwerpen (BE); Eefje Colman, Lierde (BE); Luc Quix, Mechelen (BE)

(21) Appl. No.: 13/345,622

(22) Filed: Jan. 6, 2012

Related U.S. Application Data
(60) Provisional application No. 61/430,539, filed on Jan. 6, 2011.

(51) Int. Cl. G06F 17/30

(52) U.S. Cl. 707/687; 707/E17.005

(57) ABSTRACT

A method for processing personnel change requests (PCRs), the method including: identifying a wizard configured for a particular PCR of the PCRs, the PCR having multiple steps; invoking the wizard for guiding a user through first ones of the steps, the first ones of the steps prompting the user for a first set of data associated with the PCR; storing the first set of data in a temporary storage device; invoking the wizard for guiding another user through second ones of the steps, the second ones of the steps prompting the another user for a second set of data associated with the PCR; storing the second set of data in the temporary storage device; monitoring a status of the PCR; and transferring the first and second sets of data from the temporary storage device to a database in response to detecting a particular status of the PCR.

### CROSS-REFERENCE TO RELATED APPLICATIONS

This non-provisional application claims the benefit of U.S. Provisional Patent Application No. 61/430,539, filed on Jan. 6, 2011, the entire disclosure of which is incorporated by reference herein.

This application is also related to U.S. Application entitled System and Method for Accessing a Database Including Data Abstraction Layer and Request Table Processing (attorney docket N405:68803), filed on even date herewith, the content of which is incorporated herein by reference.

### BACKGROUND

Computer databases are commonly used by companies to store and track information related to human resources (HR) management. Exemplary data that may be stored and tracked by a company include, for example, an employee's personal information, starting date, salary, attendance record, and the like. Such information can all be stored electronically in software systems provided by companies such as SAP® and Oracle®.

One drawback to existing human resource management systems is that the user interfaces provided by such systems are often very limited. Changing information or adding new information to the database may therefore require low-level database commands to be executed directly by a specialist of the database systems. In addition, because the database entries operate at a low level and are made directly to the database, it may be difficult for multiple system users (e.g., employees, managers, and HR administrators) to collaborate using the HR system. Thus, changes to the database may have to be processed on paper or in electronic documents which must still then be manually input to the system.

Accordingly, what is desired is an HR system which facilitates the creating, changing, and deleting of personal and personnel data while at the same time allowing multiple actors to act on the data that is created or changed, all without prematurely and unnecessarily accessing or modifying data in the underlying HR database.

### SUMMARY

Aspects of the present invention are directed to a human resources management system and method having an improved user interface in which a workflow for making changes to personnel information (e.g., an employee's address, salary, position in company, manager, etc.) through a personnel change request (PCR) is integrated with an underlying HR database system such that changes can be made to the database without the manual execution of low level database commands or special operator training. According to one embodiment of the invention, the changes are made through a simple web-browser-based interface (e.g. a wizard).

According to one embodiment of the present invention, multiple users collaboratively contribute to a PCR using the integrated system and save the data within the system in a temporary database without causing data to be written to main portions of the HR database (or “working database”) that are used for day-to-day operations. In this way, the consistency and atomicity of the system are improved because changes are only written to working database when the PCR is complete (and approved, if necessary).

According to one embodiment of the present invention, a method for processing a plurality of personnel change requests (PCRs) includes: identifying a wizard configured for a particular PCR of the PCRs, the PCR having a plurality of steps; invoking the wizard for guiding a first user through first ones of the plurality of steps, the first ones of the plurality of steps prompting the first user for a first set of data associated with the PCR; storing the data input by the first user in a buffer; invoking the wizard for guiding a second user through second ones of the plurality of steps, the second ones of the plurality of steps prompting the second user for a second set of data associated with the PCR; storing the data input by the second user in the buffer; monitoring a status of the PCR; and transferring the data input by the first and second users from the buffer to a database in response to detecting a particular status of the PCR, the database being configured to store personnel information.

The particular status may be completion of the plurality of steps of the PCR or the approval of the PCR. The method may also include transmitting a request for the approval to a third user; displaying the request on a display device associated with the third user; and receiving data indicative of the approval from the third user.

The data input by the first user may be stored in the buffer in response to a save command or in response to a command to proceed to a next step of the PCR from a current step.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic block diagram of a human resource management system according to one embodiment of the invention.

FIG. 2A is a process flow diagram illustrating a method of creating a wizard according to one embodiment of the present invention.

FIGS. 2B, 2C, and 2D are screenshots illustrating aspects of the method of creating a wizard shown in FIG. 2A according to one embodiment of the present invention.

FIG. 2E is a screenshot of a step in a wizard according to one embodiment of the present invention.

FIG. 2F illustrates a data structure used to store a wizard according to one embodiment of the present invention.

FIG. 3A is a screenshot of a personnel change request overview page according to one embodiment of the present invention.

FIGS. 3B, 3C, and 3D are screenshots of an “overview possible actions” widget as viewed by a regular employee, a manager, and an HR administrator, respectively, according to one embodiment of the present invention.

FIGS. 3E and 3F are screenshots of a history and pending requests widget showing a list of PCRs and an expanded PCR, respectively, according to one embodiment of the present invention.

FIGS. 4A, 4B, and 5 are process flow diagrams for executing a wizard according to embodiments of the present invention.

FIG. 4C is a screenshot of a step in a wizard according to one embodiment of the present invention.

FIG. 6 is a screenshot of an inbox of a user having a plurality of actions including PCRs according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

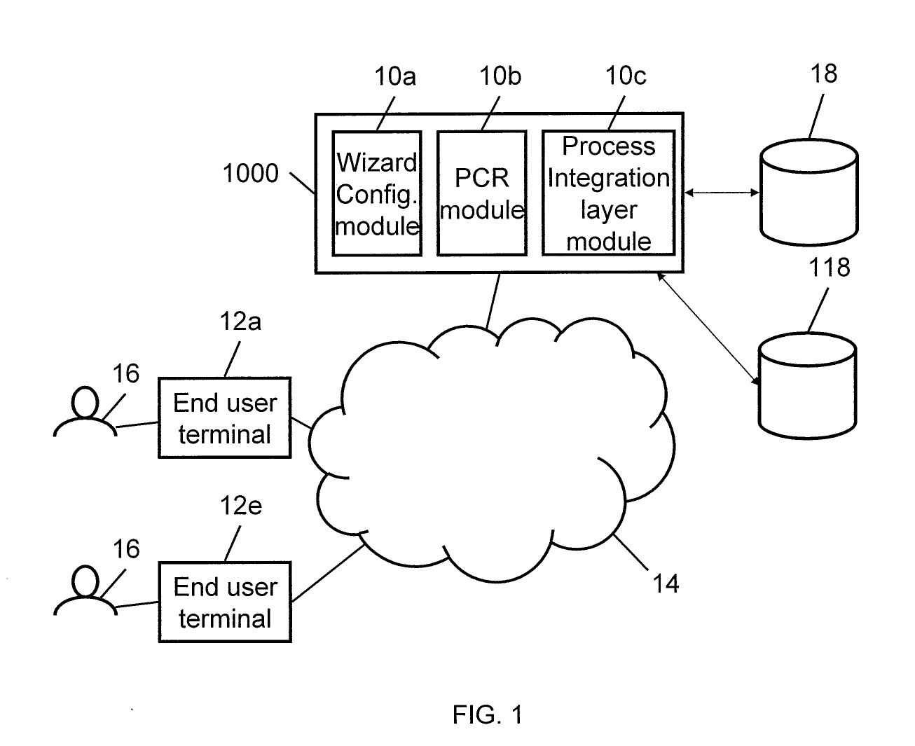

FIG. 1 is a schematic block diagram of an HR management system according to one embodiment of the invention. The system includes a server 10 coupled to various end user terminals 12a-12e (collectively referred to as 12) over a data communications network 14 such as, for example, a public Internet, a local area network, or a virtual private network. The users (or actors) 16 may include employees, managers, HR professionals, service customer agents, non-employee personnel, and other people associated with an organization.

The server 10 is also coupled to one or more database servers 18. The database server 18 includes a processor, a memory, a persistent data store (or mass storage device, e.g., a disk drive or drive array), and a communications device. Computer software modules stored in the memory implement database features in the database server which allow data to be written to and read from the persistent data store. Software modules capable of implementing such features include packages from SAP®, Oracle®, PostgreSQL®, and others. The database server 18 may also include a plurality of servers working together or may be running on the server 10 in a virtualized machine or directly on the server 10. According to one embodiment, the database server 18 stores an HR database which may be used to store personnel (or employee) information such as title, salary, benefits information, location, working hours, vacation requests and approvals, etc. According to one embodiment, the database server 18 may also store a temporary database for temporarily storing PCR requests.

The server 10 also includes one or more software modules for providing various services to the end terminals. Such software modules may include a wizard configuration module 10a for allowing the end users 16 to configure the server 10 via the end user devices 12, a Personnel Change Request (PCR) module 10b for allowing the end users 16 to submit and process requests, and a process integration layer module (or “abstraction layer”) 10c for managing the interactions between the wizard configuration module 10a, the PCR module 10b, and the database server 18. The process integration module 10c is described in further detail in “System And Method for Accessing a Database Including Data Abstraction Layer And Request Table Processing”, filed on even date herewith, the content of which is incorporated herein by reference. The software modules 10a, 10b, and 10c running on the server 10 may be collectively referred to as a workspace. The workspace may also include other software modules which will be apparent to a person of skill in the art. Although the various modules are described as computer program instructions which are stored in memory and executed by one or more processors hosted by the server 10, a person of skill in the art should appreciate that the modules may also be implemented via hardware, firmware (e.g. ASIC), or a combination of hardware, firmware, and software.

The server 10 is also coupled to a persistent data store (or mass storage device) 118 separate from the persistent data store of the database server 18, for storing information used by the server 10 for providing the various services. For example, the persistent data store may store server configuration information and user customizations, messages sent between users, saved drafts of requests (or transactions), pending requests, and the like.

According to one embodiment of the invention, the end user devices 12 and/or the servers 10 and 18 may connect to the data communications network 14 using a telephone connection, satellite connection, cable connection, radio frequency communication (e.g., cellular data communication), or any wired or wireless data communication mechanism known in the art. To this end, the devices may take the form of a personal computer (PC), hand-held personal computer (HPC), television and set-top-box combination, personal digital assistant (PDA), smartphone, or any consumer electronics device known in the art.

According to one embodiment, a PCR is an action executed by the workspace enabling a manager, an employee, an HR administrator, or other user to perform some changes related to their professional or private lives via a multi-step process. The workspace sequences the sub-actions of an action (or a PCR) to be taken into steps; manages the actors to be involved in the different steps; allows different actors to create, change, delete, approve, and notify actions; and allows multiple actors (e.g., employees, managers, HR administrators, etc.) to concurrently act on and make changes to data that is being created, changed, or deleted, without prematurely or unnecessarily committing any changes to the database. According to one embodiment, the workspace temporarily saves the PCRs received from the users in a request table of the temporary database that is commonly accessible to various users, without writing to the underlying HR database hosted by the database server 18. That is, users may enter the PCRs during one or more sessions, and the partially completed PCRs can be passed between users without writing to the underlying human resources database. The PCR is written to the human resources database stored in database 18 when the PCR is ready for submission, thereby improving the concurrency of access and the consistency of the database. According to one embodiment, the request table is implemented as a separate table or a collection of tables stored in the same database as the HR database running on the database server 18, or in a database separate from the HR database. In other embodiments, the request table may be stored in a separate database system running on the same server (e.g., server 10) that the workspace is running on, or may be stored using other persistent methods of storage. According to one embodiment, PCR information is stored in persistent memory that is shared between the users (e.g., on the server 10 or database server 18) in a manner that does not impact ordinary access to the other data stored in the database server 18.

In addition, the term “commonly accessible” is used to indicate that the data is stored in a location that is accessible by any user 16 having sufficient permissions from any end user terminal 12, and not that any user 16 may have access to it. In general, a user 16 may have access to the data stored in the system if sufficient permissions are granted to that user by the system.

According to one embodiment of the invention, a user may change a complex set of HR data without invoking low level database commands for accessing and modifying the data directly from the database. In this regard, the HR system according to embodiments of the present invention provides a PCR wizard for each type of PCR accepted by the system. For example, an address wizard allows entry or change of an employee's address, a birthday wizard allows entry or change of an employee's birthday, and a healthcare benefits wizard allows an employee to enroll in or modify their healthcare benefits. According to one embodiment, each PCR wizard is a graphical user interface which sequences the corresponding PCR action to be taken into various steps, and guides the user through each step at a time. The data that is provided at each wizard step is not saved directly into the data structures of the HR database, but instead, temporarily stored in the request table until the conditions for saving it into the database are satisfied. Such conditions include, for example, the approval of the PCR once it is submitted, or the completion of the various steps of the PCR. According to one embodiment, multiple actors may access the same PCR to complete the sequence of steps of the PCR.

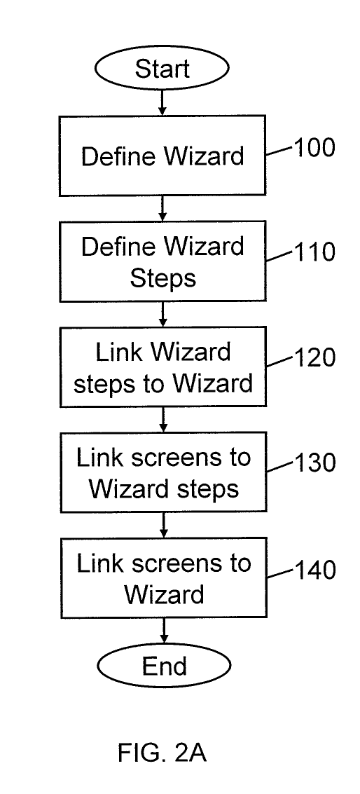

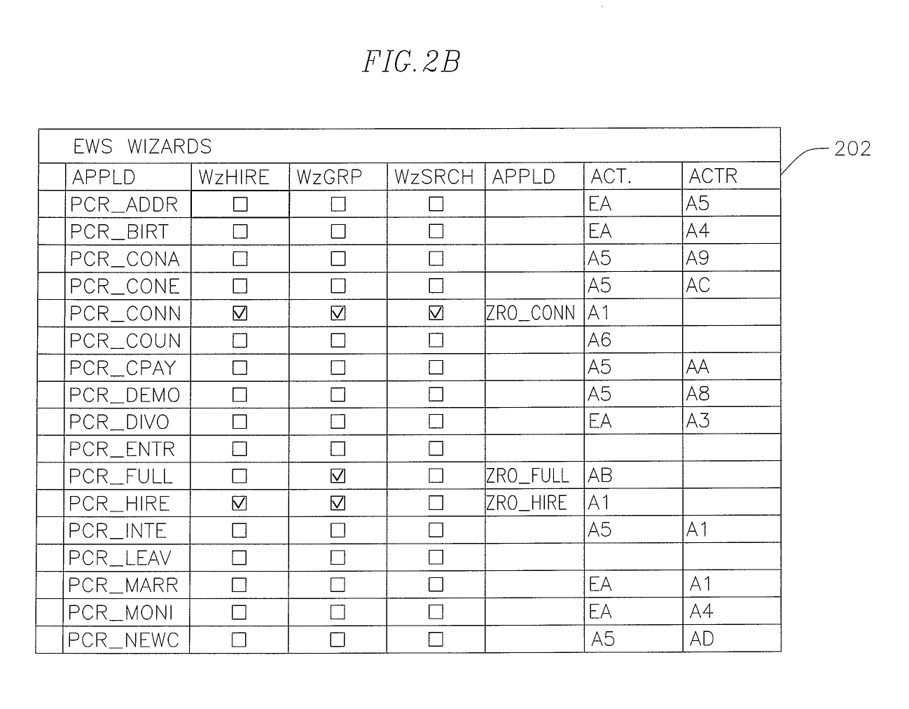

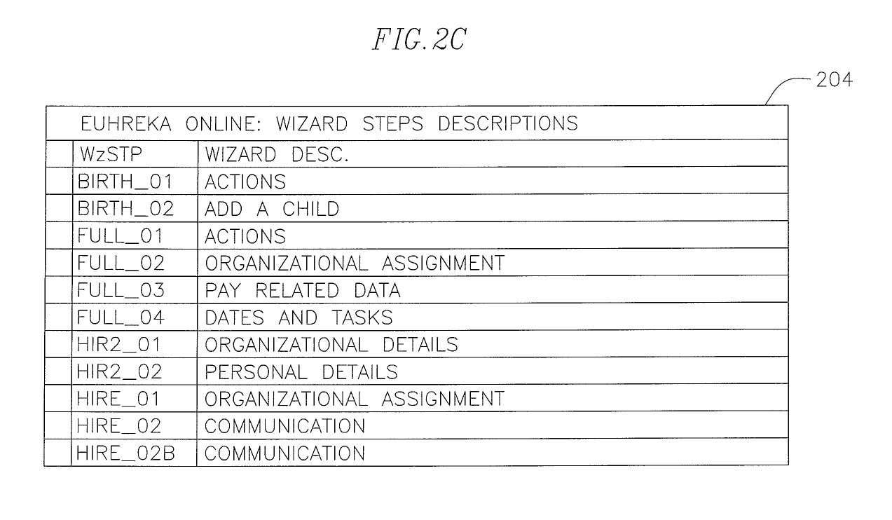

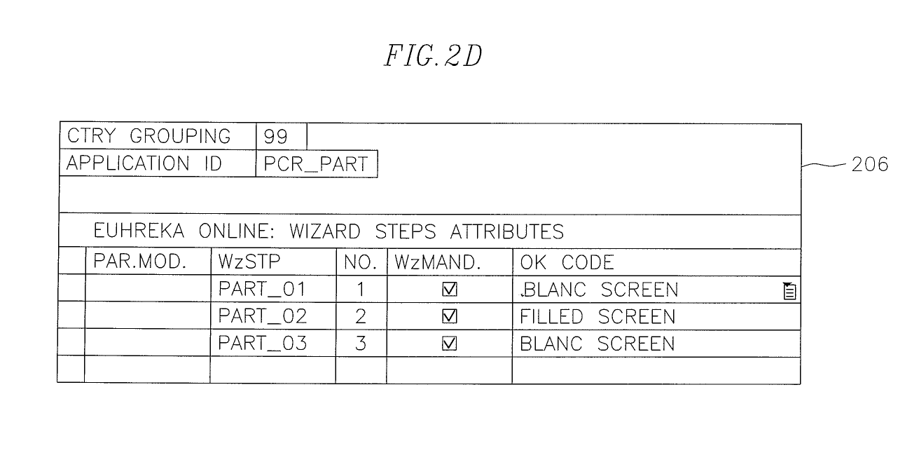

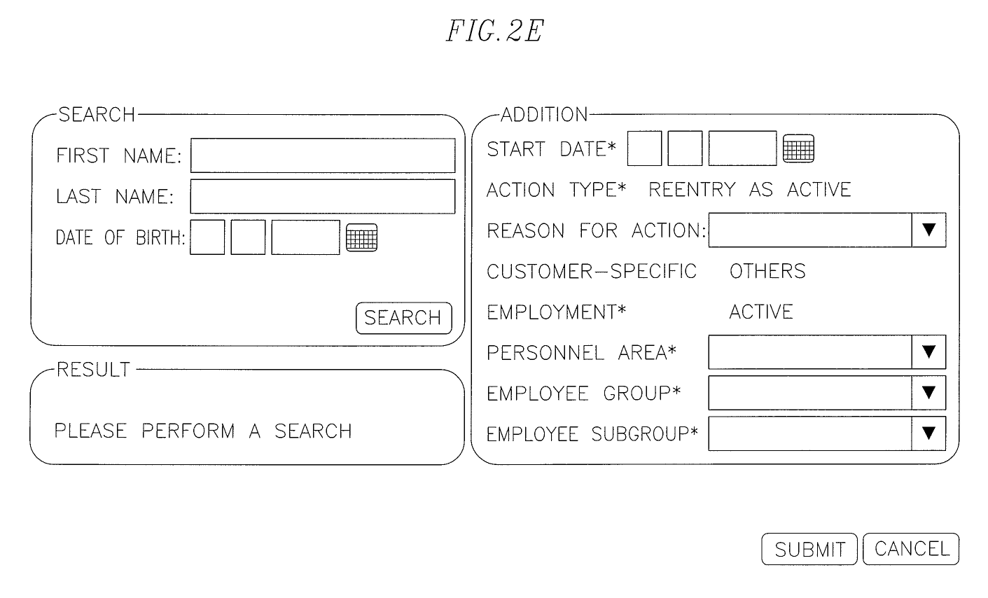

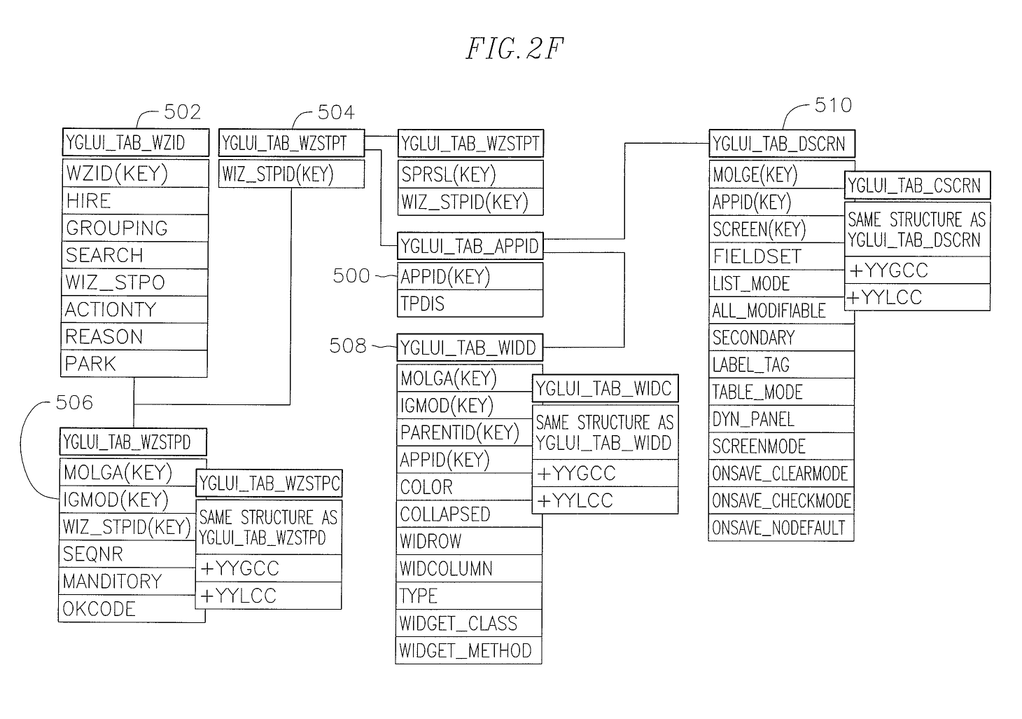

FIG. 2A is a process flow diagram executed by the wizard configuration module 10a for configuring a PCR wizard according to one embodiment of the invention. The sequence of steps of the process is not fixed, but can be altered into any desired sequence as recognized by a person of skill in the art. Steps in the process flow diagram shown in FIG. 2A will be described in conjunction with the screenshots of FIGS. 2B through 2F.

As illustrated in the screenshot of FIG. 2B, according to one embodiment of the present invention, each PCR wizard is associated with a number of fields:

A wizard ID (AppId) is a unique identifier of a workspace wizard and may be an APPID defined in a global APPID table (e.g., YGLUI_TAB_APPID).

Hire (WzHire) is a flag used to indicate whether the wizard is a hire process. A hire process may involve special logic because when a hire process is started, the accessed object (pernr) is not known (e.g., may not yet be created) and this therefore may require special treatment. For example, during a hiring process, a new employee being hired may not already have an associated object or record in the system, and therefore special treatment may be required to handle the creation of a new object or record for that employee.

Grouping (WzGrp) specifies whether the wizard requires an initial step which, for some types of wizards, is configured to be completed before determining the actual number of steps for the wizard based on the information entered in the initial step. According to one embodiment, indicating this flag prompts an entry in a ‘Wizard 0 step’ field. The core fieldset used to build the grouping screen in the 0 step is called ‘PCR_ADDITION’. All mandatory and editable fields may at least be part of any country and/or customer specific fieldset that is used in a wizard 0 step for the grouping screen.

Search (WzSrch) specifies whether the wizard needs to perform a search on a person in an initial step before determining the actual number of steps. Indicating this flag will require an entry in the ‘Wizard 0 step’ field.

The Wizard 0 step field (or zero step) specifies whether an initial step is to be processed before starting the actual flow of determined wizard steps. This field specifies the AppId of the step that should be performed as the initial step. Several screens and fieldsets can then be linked to this appid to be visible in the zero step. Defining a zero step implies that the action linked to the wizard will be saved in a data type (e.g., data type 0000) based on the information entered in the grouping screen. According to one embodiment, a zero step may be needed when the action linked to the wizard triggers a change in the status codes.

Action (Act) is an optional field which specifies an action code of the database (e.g., an SAP® action) that is linked to the wizard.

Reason (ActR) is an optional field which specifies a reason code of the database which provides the default reason for the action (if any) associated with the wizard.

Referring to the flow chart of FIG. 2A, the wizard configuration module 10a defines the values of the above described fields for a particular PCR wizard. The PCR wizards may be listed in an WIZARDS table 202, as shown, for example in FIG. 2B.

In step 110, the wizard configuration module defines a plurality of wizard step descriptions according to a table as shown, for example, in table 204 shown in FIG. 2C. Each step of the wizard is provided with a unique Wizard step 1d (WzStp) and is also defined in the global AppId table such that each step can later be linked to contextual actions. In addition, each step is provided with a human readable description (Wizard Desc.).

In step 120, the wizard configuration module links the defined wizard steps to a wizard. As illustrated in the example table 206 shown in FIG. 2D, each wizard is also associated (e.g., through a reference to the AppId of the wizard) with a table indicating each of the steps of the wizard. Each step of the wizard includes: a Wizard step 1d (which was defined in 110); a sequence number (No.), which indicates the order in which the wizard steps should be processed; a mandatory flag (WzMand.) which indicates whether navigating to the next step is only possible when all mandatory fields within the wizard steps are processed (and simulated) without errors. Optional steps (e.g., steps in which the mandatory flag is not set) can be skipped and no simulation or saving is done. An OK Code indicates whether the next step involves a call for existing records to be displayed or a call for the creation of records. For example, the OK Code may contain the value “NEW” if the wizard step needs to display an empty record with defaulting.

Next, the wizard configuration module is used to link screens to wizard steps. It is possible to show multiple screens and position them in one step. The parent Id of each screen is the Wizard step 1d to which the screen belongs.

In step 130, the wizard configuration module links screens to the wizards, e.g., by linking in the screen definition table (e.g., YGLUI_VIE_(D|C)SCRN) where wizard id is linked to screens.

If necessary, the wizard configuration module is also used to define a zero step for the wizard. Configuration of the zero step is similar to any other AppId that can contain screens. This may involve: defining an APPID in an application definition table (e.g., YGLUI_TAB_APPID); defining the positions and types of the screens for the zero step in a widget definition table (e.g., YGLUI_TAB_WID(D|C)), where APPID is set to the zero step APPID; linking screens and fieldsets to the zero step in a screen definition table (e.g., YGLUI_TAB_(D|C)SCRN); and configuring the O-step application buttons. FIG. 2E is a screenshot of a zero step screen according to one embodiment of the present invention.

The data associated with a wizard may be stored in a plurality of tables which are linked to one another according to the model illustrated in FIG. 2F.

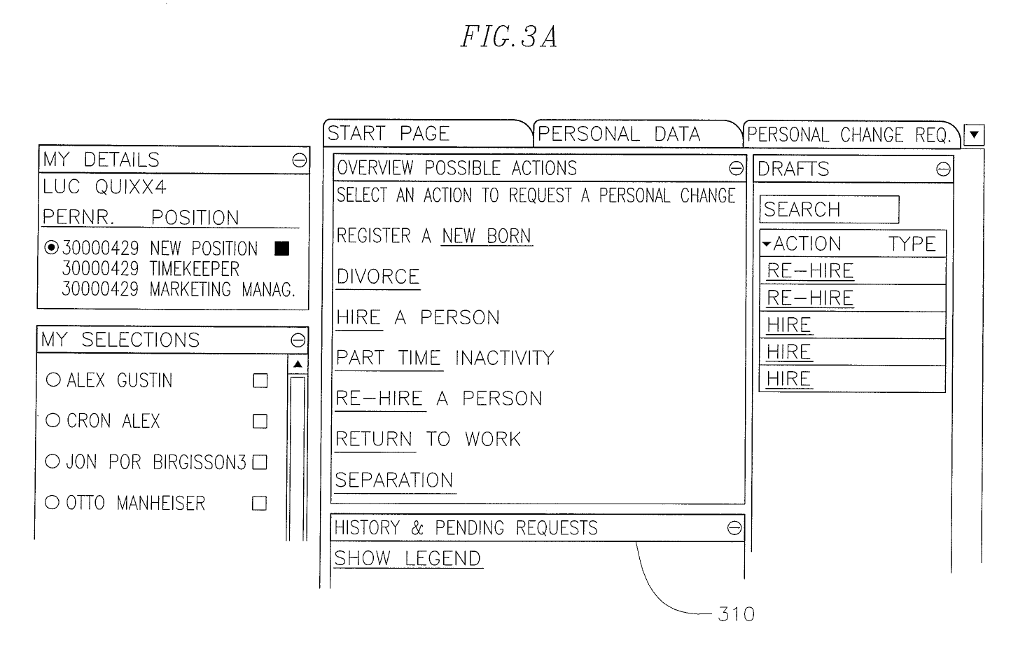

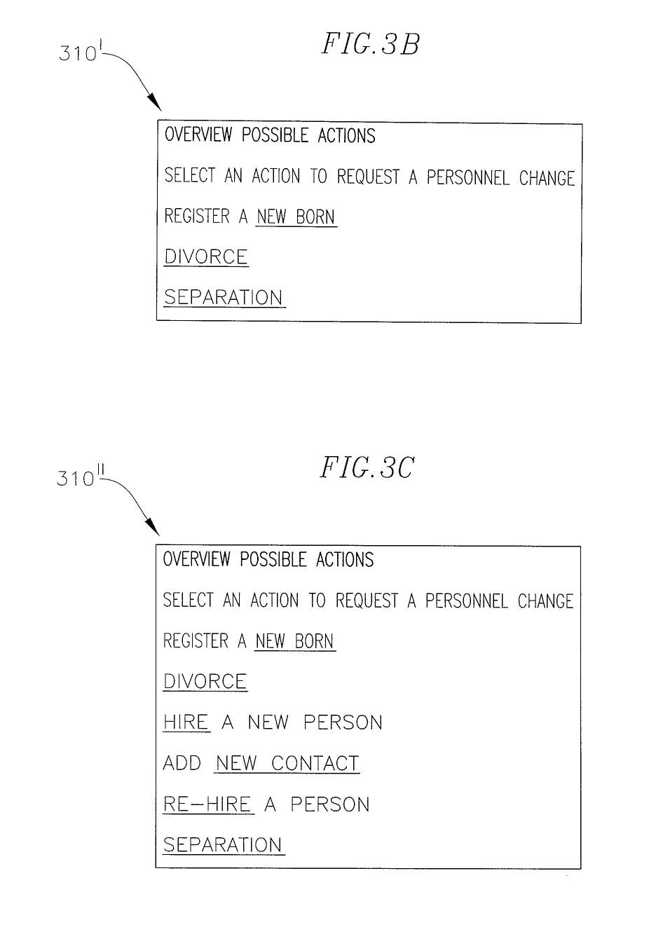

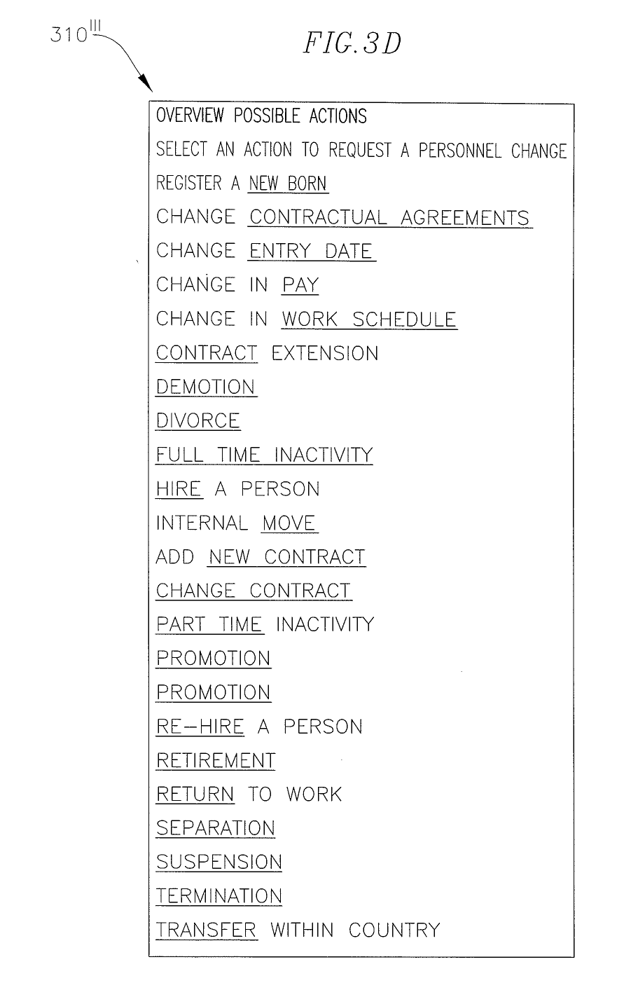

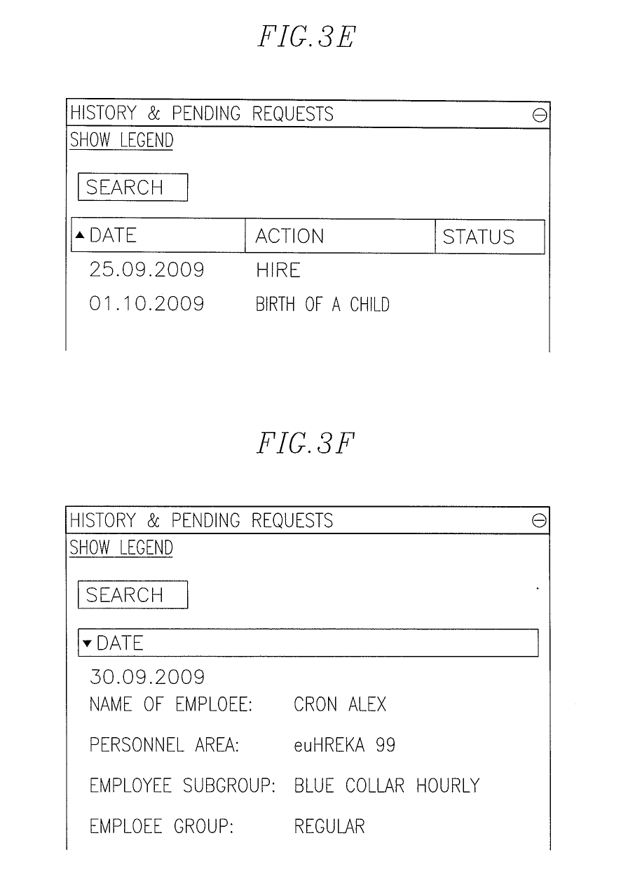

The configured wizards are accessed for guiding a user to provide the data that is used to initiate or complete a personnel change request. In this regard, the PCR module 10b provides a PCR overview page via an “overview possible actions” widget including three types of widgets that a user may access for effectuating a personnel change request. FIG. 3A is a screenshot of a PCR Overview page according to one embodiment of the present invention. As seen in FIG. 3A, the three types of widgets may include (but are not limited to) an overview of possible actions 310 (e.g., actions that the current user is allowed to take), drafts (e.g., actions that have been partially completed and have not been submitted), and history & pending requests (e.g., actions which have been submitted and which have been completed or are still pending due to, e.g., requiring approval from another user).

According to the roles or location of the user in the company hierarchy, the possible actions are different from one user to another. If a manager selects oneself, he/she will be able to see the actions that he/she is allowed to perform for herself/himself. If the manager selects one of his/her employees, he/she will be able to see the actions he/she is allowed to perform for this employee.

For example, a manager may have access to more functionality than an employee, and an HR administrator may have still further functionality available. Table 1 illustrates options that are available to an employee, a manager, and an HR administrator according to an embodiment of the present invention. FIGS. 3B, 3C, and 3D are screenshots of an “overview possible actions” widget (310′, 310″, and 310′″) indicating the PCRs available to an employee, a manager (on himself), and an HR administrator, respectively. As can be seen in the illustrated examples, an employee only has access to note personal events such as marriage, separation, divorce, and the birth of a child. In contrast, a manager has the ability to provide promotions and changes in pay while an HR Administrator has access to a much broader range of PCRs.

TABLE 1

| | | | HR |
|---|---|---|---|
| PCR | Employee | Manager | Administrator |
| Hire | | | X |
| Re-hire | | | X |
| Termination | | | X |
| Retirement | | | X |
| Part Time Inactivity | | | X |
| Return to Work | | | X |
| Full time Inactivity | | | X |
| Personal Events | | | |
| Marriage | X | X | X |
| Separation | X | X | X |
| Divorce | X | X | X |
| Birth of child | X | X | X |
| Change person situation | | | |
| Promotion | | X | X |
| Demotion | | | X |
| Internal Move | | X | X |
| New Contract | | | X |
| Contract Extension | | | X |
| Change Contractual Agreements | | | X |
| Change in pay | | X | X |
| Change in work schedule | | X | X |
| Transfer within country | | | X |

The history and pending requests widget allows users to view previously submitted PCRs and may include a date selector so that PCRs from particular date ranges can be displayed. FIG. 3E is a screenshot of a history and pending requests widget with a search bar and brief summaries of the previous PCRs. The PCRs listed in the history and pending requests widget can be expanded to view additional details of the PCR, as illustrated in FIG. 3F.

The drafts wizard lists PCRs that the user may have started to complete (e.g., by following through the associated wizard) but may have saved for completion or submission later. Drafts can be deleted or searched through the widget.

According to one embodiment, a wizard guiding a user through various steps of a PCR generally prompts the user to enter information during these steps. Some of the requested information (or “fields”) may be compulsory before the wizard will allow the user to proceed to the next step while other fields may be optional. Some steps may request only compulsory or only optional information (which would make it an optional step). Information provided in one step may change the steps that are presented later on, or may change whether some later fields are optional or compulsory.

Some PCRs may also require a preliminary step before beginning the PCR, referred to as a zero step. For example, when a search for matching data objects is required before beginning the PCR or when employee grouping, employee subgrouping, and personal area are known and the user needs to indicate them in appropriate fields, such actions may require a zero step. For example, a re-hiring PCR uses a zero step because a search for former employees is performed first before beginning the re-hiring PCR, and because the employee grouping, employee subgrouping and personal area have to be indicated. The workspace may then select an appropriate PCR wizard from a plurality of PCR wizards based on the information provided in the zero step.

The other steps of the wizard (e.g., the steps other than the zero step) are presented as a chain of screens. Navigating from one step to the next can be done by selecting “next” once all compulsory fields have been filled in; by selecting on the next step number once all compulsory fields have been filled in; or by selecting “skip” on a non-compulsory step. When selecting a step number, only steps up to the next compulsory step are available for selection to ensure that all of the compulsory information is entered in order.

On each screen associated with each step of the wizard, the navigation options available to the user depend on the user's progress through the wizard.

1st step:
Next: save (in request table) & navigate to next step
Save: save current step in draft (in request table)
Submit: submit whole PCR, when a collection of necessary steps are OK, the data can be saved to the temp tables and a workflow can be invoked to request additional users to complete and/or approve the PCR.
Cancel: quit the wizard=>a confirmation button appears asking the user if he/she wants to save the data. If he/she clicks on ‘No’, the data is not saved and the PCR is canceled. If the user clicks on ‘Yes’, the data is saved, the user leaves the PCR and the PCR goes to the ‘Drafts’ widget.

Intermediate steps:
Next: save (in request table) & navigate to next step
Save: save current step in draft (in request table)
Previous: navigate to previous step (without saving if the user didn't click on the save button)
Submit: submit whole PCR, when a collection of necessary steps are OK, the data can be saved to the temp tables and a workflow can be invoked to request additional users to complete and/or approve the PCR.
Cancel: quit the wizard=>a confirmation button appears asking the user if he/she wants to save the data. If he/she clicks on ‘No’, the data is not saved and the PCR is canceled. If the user clicks on ‘Yes’, the data is saved, the user leaves the PCR and the PCR goes to the ‘Drafts’ widget.

Last step:
Save: save current and previous steps in draft (in request table)
Submit: submit whole PCR, when a collection of necessary steps are OK, the data can be saved to the temp tables and a workflow can be invoked to request additional users to complete and/or approve the PCR.
Previous: navigate to previous step (without saving if the user didn't click on the save button)
Cancel: quit the wizard=>a confirmation button appears asking the user if he/she wants to save the data. If he/she clicks on ‘No’, the data is not saved and the PCR is canceled. If the user clicks on ‘Yes’, the data is saved, the user leaves the PCR and the PCR goes to the ‘Drafts’ widget.

The saving of the draft (e.g., after each step or when the save function is selected) results in the information entered into the wizard being saved in a commonly accessible location such as a request table in the database running on the database server 18. Because the data is saved in this commonly accessible location, the user is able to, for example, pause at any point while proceeding through the wizard, save his progress, and resume entering data at another time (even during another login session or from a different end terminal) without losing his place.

As another example, one user (e.g., an employee) may begin a PCR and enter some information, save his progress, and another user (e.g., manager) may continue entering information into the PCR that the first user may not have been able to provide. Additional authorized users may also add information to the PCR until it is complete and ready for submission. The PCR may require approval from a user (e.g., an HR administrator) before the information is written to the database. In this way, the workspace allows collaborative drafting of PCRs in part because the draft PCRs are saved in a commonly accessible location.

In addition, because the draft PCRs are saved in the request table and data is not written into the working database until the particular status of the PCR indicates that it is ready to be written (e.g., when the PCR is complete and/or, if necessary, approved), the saving of the information does not affect consistency of the main database that hold current information about the company and its employees (e.g., the database will not contain incorrect information due to the addition of information regarding the same transaction from different users at different times because all information regarding), and the workspace thereby provides atomicity to the entry of PCRs which require actions from multiple users.

For example, when hiring a new employee, an HR manager may start a hiring PCR and might add information from the candidate's application form to the PCR. Various interviewers might add comments and evaluations regarding the candidate to the PCR after the interviews and the company may decide to extend an offer to the candidate. If the candidate accepted the offer, the PCR could be completed, and the candidate's information, which was stored in the PCR in the request table, would be written to the company's main database to provide the employee's company profile. If the candidate declined the offer, the PCR associated with the candidate could be deleted from the request table without having to delete entries from the main database.

Furthermore, to provide additional protection against the inadvertent introduction of errors to the working database, during the save process the workspace may simulate the addition of the data entered during the current step of the wizard into the temporary database to validate the information. Validation may include ensuring the format of the data entered in the fields is correct (e.g., only one decimal point in the proper location or that dates are in the proper format), that numerical values fall within bounds set by the workspace or the HR system, enforcing restrictions on choosing values using autocompleters and selection boxes and other criteria that may be algorithmically evaluated by the workspace. If the data does not pass validation, the wizard may highlight the invalid fields for the user to correct before proceeding with the next step of the wizard.

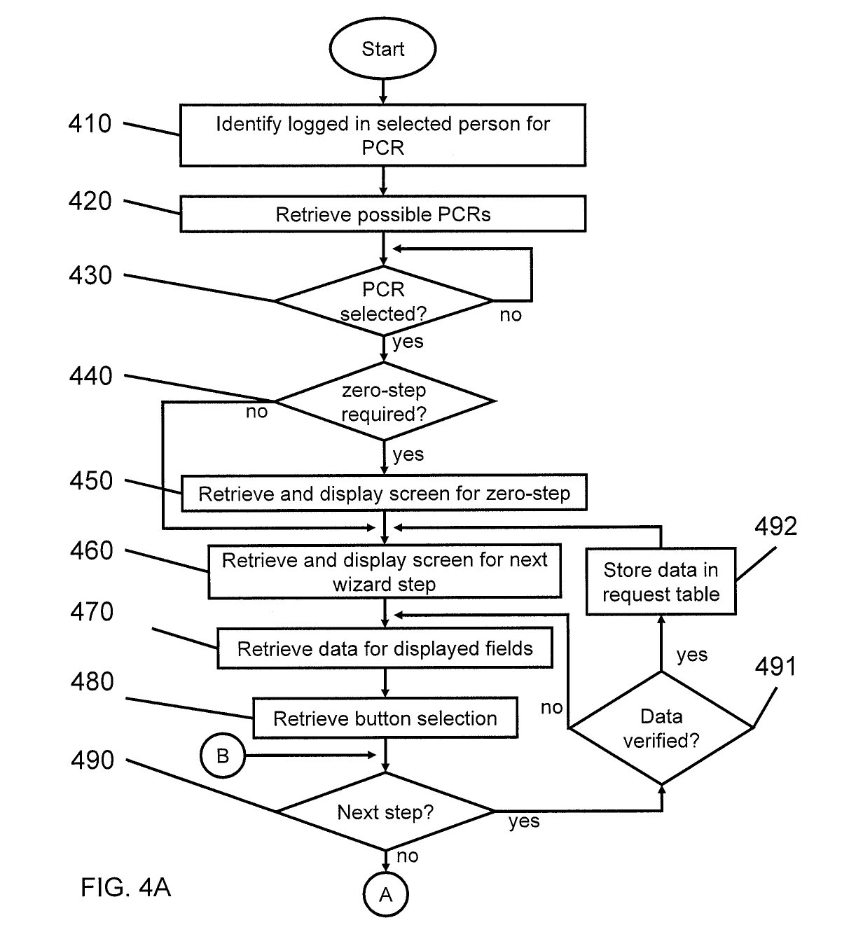

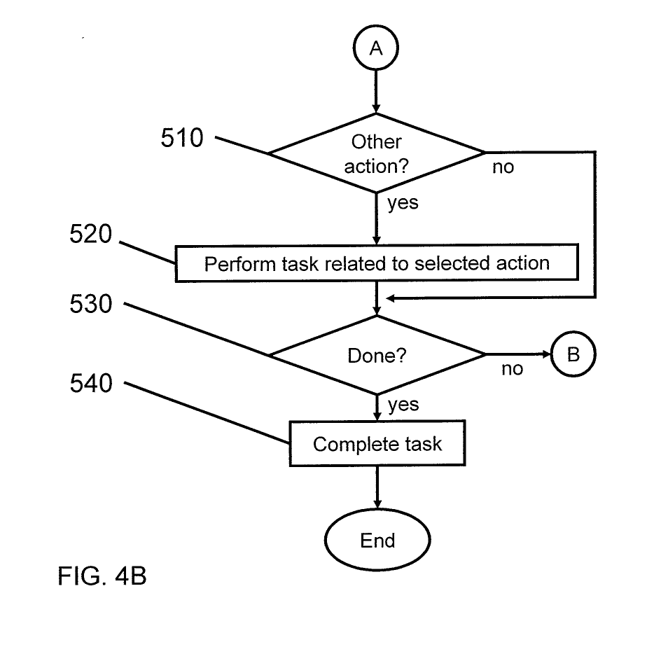

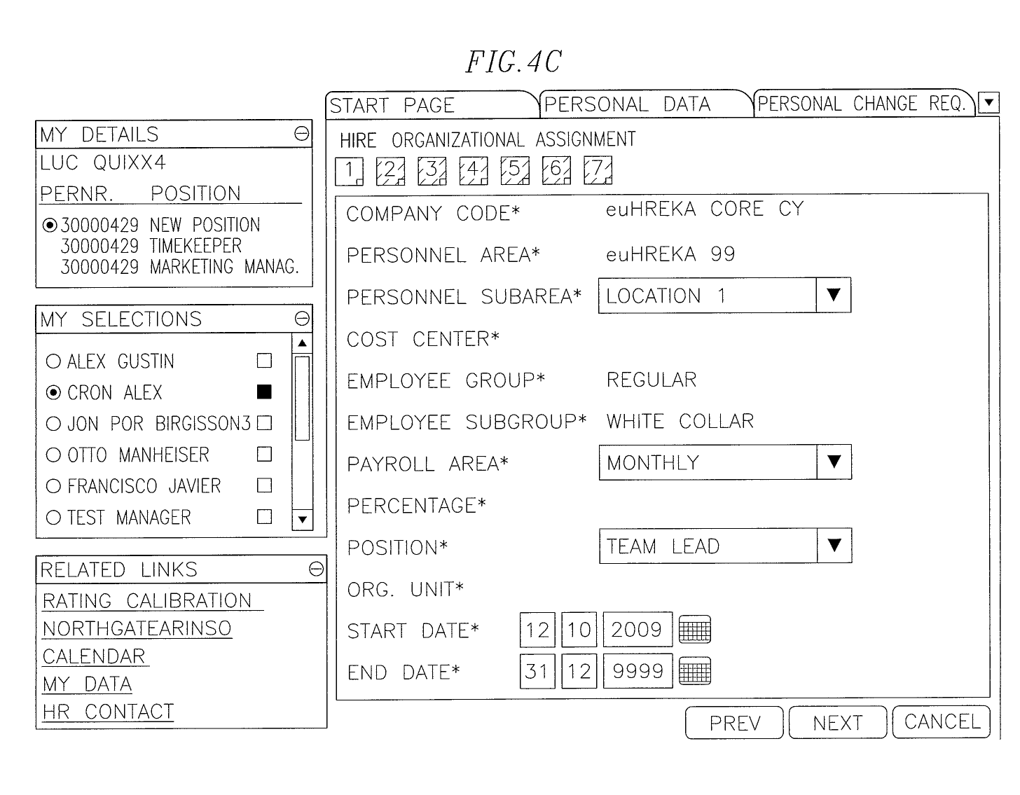

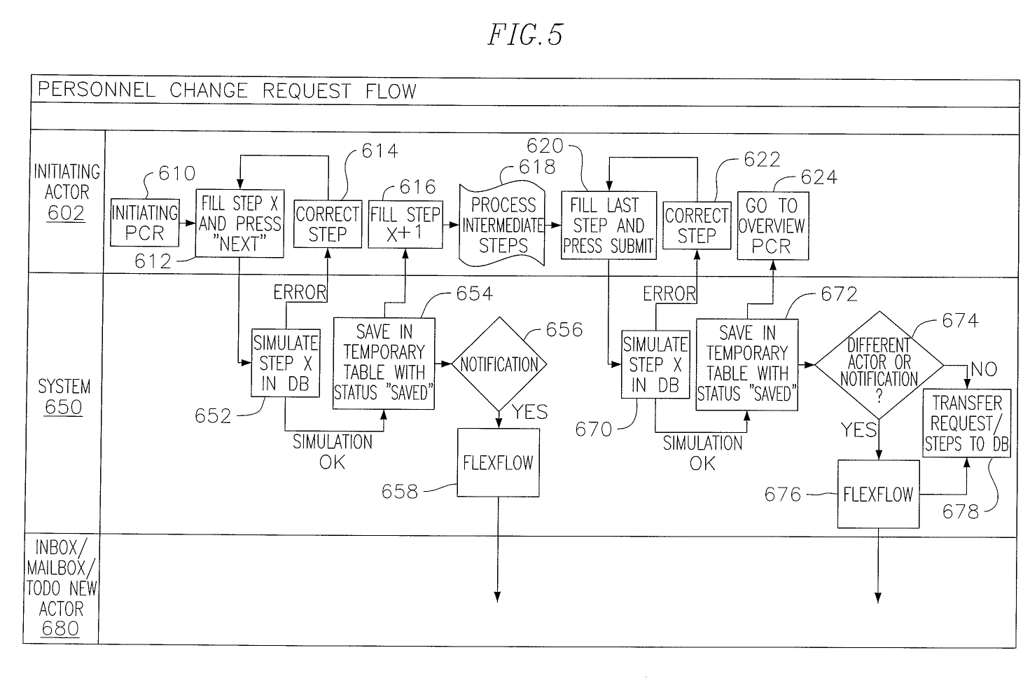

FIGS. 4A-4B are process flow diagrams executed by the PCR module 10b for processing a personnel change request selected from the “overview possible actions widget” (e.g., 310′, 310″, and 310′″ in FIGS. 3B-3D) according to one embodiment of the invention. The sequence of steps of the process is not fixed, but can be altered into any desired sequence as recognized by a person of skill in the art.

As illustrated in the embodiment shown in FIG. 4A, in step 410, the identity of the current user and the object that the user is acting on (e.g., another employee) are identified. (For example, the current user may be a manager who is acting on an object corresponding to an employee under his or her management to approve a request for a vacation.) Based on the identity of the current user, the PCR module determines a set of PCRs that the user is permitted to apply to the selected object and returns this set of permitted PCRs to the user in step 420. The PCR module then waits for receipt of user selection of one of the permitted PCRs in step 430. As discussed above, if the PCR module 10b determines, in step 440, that the selected PCR requires a zero step, the PCR module, in step 450, executes the zero step before proceeding to the other steps. For example, when entering benefits information for a new employee who does not yet have a record in the human resource database, a zero step may be used to create a record for the new employee (or to enter information that would otherwise already be available in the human resources database) before proceeding to the first step of the benefits PCR.

Steps 450-490 following the zero step are executed in a loop until all steps of the PCR wizard have been executed. In this regard, the PCR module retrieves, in step 460, a screen for the currently selected wizard step. In step 470, the PCR module receives data (e.g., supplied by the user) for the currently selected step. In step 480, the PCR module detects the selection of one of the navigation options of the displayed wizard step as described above. In step 490, a determination is made as to whether the selected option is a “next” option. If the answer is YES, the PCR module verifies the data associated with the current fields in step 491, and in step 492, saves the data in the request table. The next step in the wizard is set as the current step, and the flow cycles back to 460.

Referring again to step 490, if the selection option is not a “next” option, a determination is made in step 510 (see FIG. 4B) as to whether one of the other navigation options is selected. If the answer is YES, the PCR module performs the operations associated with the selected navigation option in step 520 according to conventional mechanisms that will be well understood to a person of skill in the art. In step 530, a determination is made as to whether the process is finished. The process may be finished because all the steps of the PCR wizard have been completed, because the user canceled the current PCR operation, or because the user has completed his portion of the PCR, which now is to be sent to another user for further work. If the answer is YES, the PCR module takes the appropriate action to complete the task in step 540 (e.g., saving the PCR, sending the PCR to next appropriate user, writing the data to the temporary database) is taken.

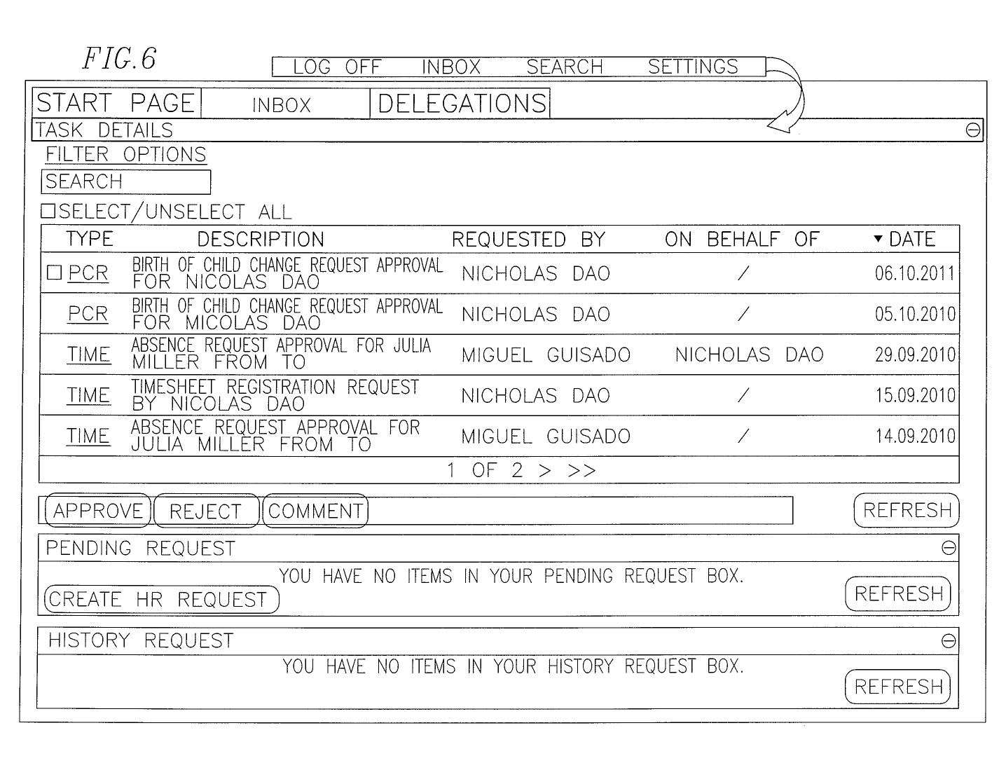

FIG. 5 is a process flow diagram illustrating a process 600 executed by the PCR module for processing a personnel change request selected from the “overview possible actions widget” according to another embodiment of the invention. In step 610, a PCR is initiated by an initiating actor (or user) 602. The initiating actor fills in step X of the PCR in step 612 (e.g., starting with step 1 or the zero step) and presses the “next” button. The system 650 then simulates the entry of step X into the database. If the simulation finds that there is an error in the data entered by the initiating actor 602, the initiating actor 602 is corrects step X in step 614. If the simulation results are ok, then the data entered is saved in a temporary table (or temporary storage device) with status “saved” in step 654. In step 656, the system monitors the status of the PCR (e.g., which steps have been completed). If the saving the entered data should generate a notification, then in step 658 the notification may cause a message or to-do item to be sent to the inbox another actor 680 as defined in a “flexflow” (or a set of further defined steps for processing). The other actor 680 may interact with the system 650 to follow further steps in the PCR in accordance with a process substantially similar to the process 600 described herein.

In step 616, the initiating actor 602 fills subsequent (or intermediate) steps (e.g., step X+1) of the PCR and these subsequent steps are processed in step 618 in a manner substantially similar to that described above with respect to step X in steps 612, 652, 614, and 654. Similarly, the last step of the PCR is filled in step 620, simulated in step 670, corrected if necessary in step 622 and saved in step 672 as described before. When the PCR is successfully completed, the initiating actor 602 is returned to the overview PCR screen in step 624. In step 674, the system 650 monitors the status of the PCR and determines whether a different actor or a notification is required for the PCR to be completed (e.g., if additional information needs to be entered by a different actor 680 or if approval from a different actor is required). If so, a notification is generated in step 676 in accordance with a flexflow in a manner similar to that described regarding step 658, in which a message or to-do item is sent to the inbox of another actor 680. If no further actions by other actors or notifications are required (e.g., the system 650 detects the completion of the PCR) then in step 678 the contents of the PCR are transferred (or written) to the human resource database.

As illustrated in the screenshot of FIG. 6, in one embodiment, the workspace also provides inboxes and notifications to notify users when PCRs require an action or attention. For example, a PCR requesting a raise may require personal information from an employee (e.g., a request for a raise), additional information from a supervisor (e.g., comments supporting or opposing the request for a raise), and approval from a manager. After the employee completes the first steps of the wizard associated with the PCR for requesting a raise, the PCR is saved in a request table and the PCR module invokes a workflow (which may be part of the PCR module or a separate workflow module) that notifies the employee's supervisor regarding the request for the raise via the workspace's messaging system (e.g., by displaying an alert or showing a link to the PCR in the supervisor's inbox). According to one embodiment of the invention, the workflow that is invoked is determined based on the identities of the receiving agents configured to receive the PCR, e.g., the time manager, HR administrator, or higher manager of the person for which the personnel change has been requested.

The supervisor views the information from the employee regarding the raise (e.g., amount of and justification for the raise) and the workflow may then prompt the supervisor to provide additional information. After the supervisor adds any additional information and completes the PCR, the workflow may be configured to notify the manager that a PCR is awaiting his approval. The manager could then review the contents of the PCR and decide whether or not to approve the raise. If the manager approves the raise (e.g., by indicating his approval on the PCR and saving the approval), then the PCR module may be configured to execute an action to write data to the HR database (e.g., updating the employee's salary and storing any other pertinent information). In this manner, the PCR data is temporarily stored in the request table until the condition for modifying the HR database is satisfied (in this case, the approval of the PCR).

Although this invention has been described in certain specific embodiments, those skilled in the art will have no difficulty devising variations to the described embodiment which in no way depart from the scope and spirit of the present invention. Furthermore, to those skilled in the various arts, the invention itself herein will suggest solutions to other tasks and adaptations for other applications. It is the applicants' intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A method for processing a plurality of personnel change requests (PCRs), the method comprising:
identifying a wizard configured for a particular PCR of the PCRs, the PCR having a plurality of steps;
invoking the wizard for guiding a first user through first ones of the plurality of steps, the first ones of the plurality of steps prompting the first user for a first set of data associated with the PCR;
storing the first set of data in a temporary storage device;
invoking the wizard for guiding a second user through second ones of the plurality of steps, the second ones of the plurality of steps prompting the second user for a second set of data associated with the PCR;
storing the second set of data in the temporary storage device;
monitoring a status of the PCR; and
transferring the first and second sets of data from the temporary storage device to a database in response to detecting a particular status of the PCR, the database being configured to store personnel information.

2. The method of claim 1, wherein the particular status is completion of the plurality of steps of the PCR.

3. The method of claim 1, wherein the particular status is approval of the PCR.

4. The method of claim 3 further comprising:
transmitting a request for the approval to a third user;
displaying the request on a display device associated with the third user; and
receiving data indicative of the approval from the third user.

5. The method of claim 1, wherein the first set of data is stored in the temporary storage device in response to a save command.

6. The method of claim 1, wherein the first set of data is stored in the temporary storage device in response to a command to proceed to a next step of the PCR from a current step.

7. The method of claim 1, wherein the wizard includes a screen for each of the plurality of steps of the PCR, wherein the first and second users navigate through the screens for providing the data prompted at each of the steps.

8. The method of claim 1, wherein the temporary storage device includes a request table for storing the first and second sets of data, wherein fields of the request table correspond to fields in the database.

9. The method of claim 1, wherein the second ones of the plurality of steps are selected from the plurality of steps in accordance with the first set of data.

10. The method of claim 1, wherein the personnel information stored in the database is independent of the storing the first and second sets of data in the temporary storage device.

11. The method of claim 1, wherein the storing the first set of data or storing the second set of data comprises:
validating the first and second sets of data;
storing the data from the temporary storage device if the validation is successful; and
aborting the storing process and displaying error messages if the validation is unsuccessful.

12. The method of claim 11, wherein the validating the first and second sets of data input comprises:
verifying the format of the data input during a step of the steps;
simulating the addition, to the database, of the data input during a step of the plurality of steps; and
verifying the consistency of the simulated database.

13. A system for managing personnel information, the system comprising:
a database configured to store the personnel information;
a temporary storage device configured to store information input by a plurality of users; and
a personnel change request processor configured to process a plurality of personnel change requests (PCRs), the personnel change request processor being configured to:
identify a wizard configured for a particular PCR of the PCRs, the PCR having a plurality of steps;
supply the wizard for guiding a first user of the plurality of users through first ones of the plurality of steps, the first ones of the plurality of steps prompting the first user for a first set of data associated with the PCR;
store the data input by the first user in the temporary storage device;
supply the wizard for guiding a second user of the plurality of users through second ones of the plurality of steps, the second ones of the plurality of steps prompting the second user for a second set of data associated with the PCR;
store the data input by the second user in the temporary storage device;
monitor a status of the PCR; and
transfer the data input by the first and second users from the temporary storage device to the database in response to detecting a particular status of the PCR.

14. The system of claim 13, wherein the particular status is completion of the plurality of steps of the PCR.

15. The system of claim 13, wherein the particular status is approval of the PCR.

16. The system of claim 15, wherein the personnel change request processor is further configured to:
transmit a request for the approval to a third user of the plurality of users;
display the request on a display device associated with the third user; and
receive data indicative of the approval from the third user.

17. The system of claim 13, wherein the personnel change request processor is configured to store the data input by the first user in the temporary storage device in response to a save command.

18. The system of claim 13, wherein the second ones of the plurality of steps are selected from the plurality of steps in accordance with the data input by the first user.

19. The system of claim 13, wherein the personnel information stored in the database is independent of the storing the data input by the first user and the data input by the second user in the temporary storage device.
